(19) United States
(12) Patent Application Publication
(10) Pub. No.: US 2008/0079686 A1
(43) Pub. Date: Apr. 3, 2008

(54) LCD panel with scanning backlight

(75) Inventor: Andrei Cernasov, Ringwood, NJ (US)

Correspondence Address: HONEYWELL INTERNATIONAL;Law Department AB 2, P.O. Box 2245, Morristown, NJ, 07962-9806, US

(73) Assignee: HONEYWELL INTERNATIONAL INC.

(21) Appl. No.: 11/528,402

(22) Filed: Sep. 28, 2006

(51) Int. Cl. G09G 3/36

(52) U.S. Cl. 345/102

(57) ABSTRACT

A liquid crystal display device (100) includes a strobing backlight source (50). The operation of the backlight source (50) and the liquid crystal (LC) layer are synchronized in such a manner that, when each LC cell is updated, the updated cell is at a specified level of transmissivity before the corresponding backlight pulse is emitted. Also, the duration and intensity of the corresponding backlight pulse are set based in order to enhance image quality and efficiency, based on the transmissivity response of the updated cell.

### FIELD OF THE INVENTION

The present invention relates to backlit liquid crystal display (LCD) panels, and more particularly, to improving the image refresh technique for such LCD panels.

### BACKGROUND OF THE INVENTION

In order to be compatible with various video and computer monitor standards, a liquid crystal display (LCD) panel upgrades its pixel outputs (i.e., liquid crystal cells) anywhere between 30 to 60 times each second. The most common applications require a 60 Hz refresh rate, which translates into an LCD upgrade period of about 17 mSecs.

However, for most existing LCD panels, the 10% to 90% response time for each liquid crystal (LC) cell is 28 mSec (i.e., this is the length of time it takes an LC cell to go from 10% transmissivity to 90% transmissivity). For more advanced (and expensive) types of LCD panels, the 10% to 90% response time is approximately 8 mSec, as illustrated in FIG. 1. These relatively long response times result in poor image quality, especially when displaying fast moving video.

To help explain this point, FIG. 2 shows the transition response characteristic of a given cell/pixel during consecutive image refresh cycles for a fast changing image sequence. In FIG. 2, the image refresh cycle is assumed to be 17 mSec, and the LC cell is initially set at minimum transmissivity (0%). As shown in FIG. 2, for the first refresh cycle, the LC cell is commanded (by an electrical drive signal at t=0 mSec) to go to maximum transmissivity level (100%). For the next image refresh cycle, the LC cell is commanded at t=17 mSec to go to minimum transmissivity (0%). Then, for the third image refresh cycle, the LC cell is commanded to go to 60% of maximum transmissivity.

Assuming the LC cell of FIG. 2 has a 10% to 90% response time of 8 mSec (as illustrated in FIG. 1), the actual response of the cell should approximately follow the curved line. FIG. 2 illustrates the desired value of transmissivity for each refresh period, as commanded by the LCD panel, as a bold line. Also, FIG. 2 illustrates a set of dotted lines representing the effective value of transmissivity, as perceived by the viewer, at the end of each refresh cycle. The effective transmissivity is the averaged value of the actual transmissivity over a 17 mSec period. In other words, the effective transmissivity value is the value of the transmissivity of the LCD, which, if constant over a 17 mSec period, would allow through the same total amount of light as the actual transmissivity of the LCD over the same 17 mSec period. [j1]

As shown in FIG. 2, there is a considerable gap for each LC cell between the desired and effective transmissivities. These gaps are illustrated as E1, E2, and E3, respectively, for the refresh periods. For LCD applications where the effective transmissivity is below the desired level, the LCD panel could compensate for this gap by increasing the overall intensity of the backlight. However, this would reduce efficiency. Furthermore, for instances where the effective value for some pixels exceeds the desired value of transmissivity, there is no way to locally add more “darkness” (while keeping neighboring pixels bright enough) in order to compensate for the gap. Thus, when displaying moving images, the LCD panel cannot get dark enough. This results in ghost images (of various colors) trailing the moving edges on the screen.

### SUMMARY OF THE INVENTION

Exemplary embodiments of the present invention are directed to a liquid crystal display (LCD) device utilizing one or more strobing backlight sources. In particular, the refresh cycle of each LC cell is synchronized with the strobe timing of one or more backlights to improve the effective transmissivity of the cell.

For instance, the strobe timing of a backlight source may be set according to a transmissivity response characteristic of a plurality of LC cells. Accordingly, when an LC cell is being updated, the backlight source may be configured to strobe on during the portion of the update cycle at which the LC cell is closest to the desired transmissivity level.

According to an exemplary embodiment, the backlight source may be configured to uniformly distribute the strobed backlight across the LCD screen. In such an embodiment, the cells in the LC layer may be updated sequentially, according to a scanning pattern. Accordingly, each cell's update cycle is synchronized to the strobe timing of a common backlight.

However, according to an alternative exemplary embodiment, a set of discrete backlight sources (e.g., local sources) may be used. In such an embodiment, the cells in the LC layer may be logically partitioned into “blocks,” each of which is synchronized to a corresponding set (or block) of one or more local backlights. As such, in each LC block, the cells are updated in synchronization with the strobe timing of the corresponding block of backlights. Further, a scanning pattern may be independently employed within each LC block for updating the cells therein. Thus, multiple LC blocks may be updated simultaneously.

Further aspects in the scope of applicability of the present invention will become apparent from the detailed description provided below. However, it should be understood that the detailed description and the specific embodiments therein, while disclosing exemplary embodiments of the invention, are provided for purposes of illustration only.

### BRIEF DESCRIPTION OF THE DRAWINGS

A more complete understanding of the present invention will become apparent from the following description taken in conjunction with the accompanying drawings, which are given by way of illustration only and, thus, are not limitative of the present invention. In these drawings, similar elements are referred to using similar reference numbers, wherein:

FIG. 1 is a graph illustrating the response time for upgrading the transmissivity in a particular type of liquid crystal (LC) cell;

FIG. 2 is a graph illustrating the transmissivity response of a particular type of LC cell based on a series of commands;

FIGS. 3A and 3B conceptually illustrate the configuration of a liquid crystal display (LCD) device, according to an exemplary embodiment of the present invention;

FIG. 4 illustrates a thin-film transistor (TFT) circuit for driving the LC cells, according to an exemplary embodiment of the present invention;

FIG. 5 illustrates the synchronization between the strobe timing of the backlight source and the updating of an LC cell, according to an exemplary embodiment of the present invention;

FIGS. 6A and 6B illustrate a type of backlight source for the LCD device, according to an exemplary embodiment of the present invention;

FIGS. 7A and 7B illustrate an alternative type of backlight source for the LCD device, in conjunction with the logical partitioning of LC cells, according to an alternative exemplary embodiment of the present invention; and

FIG. 8 illustrates the contribution of multiple backlight sources to a particular LC cell, according to an exemplary embodiment of the present invention.

### DETAILED DESCRIPTION OF EXEMPLARY EMBODIMENTS

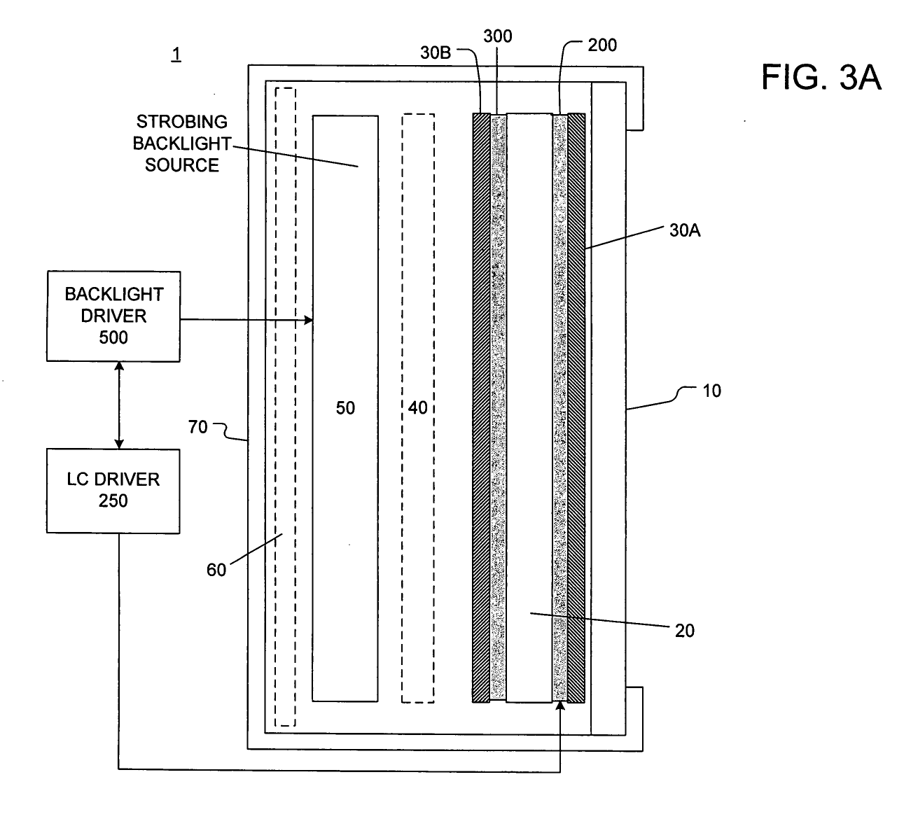

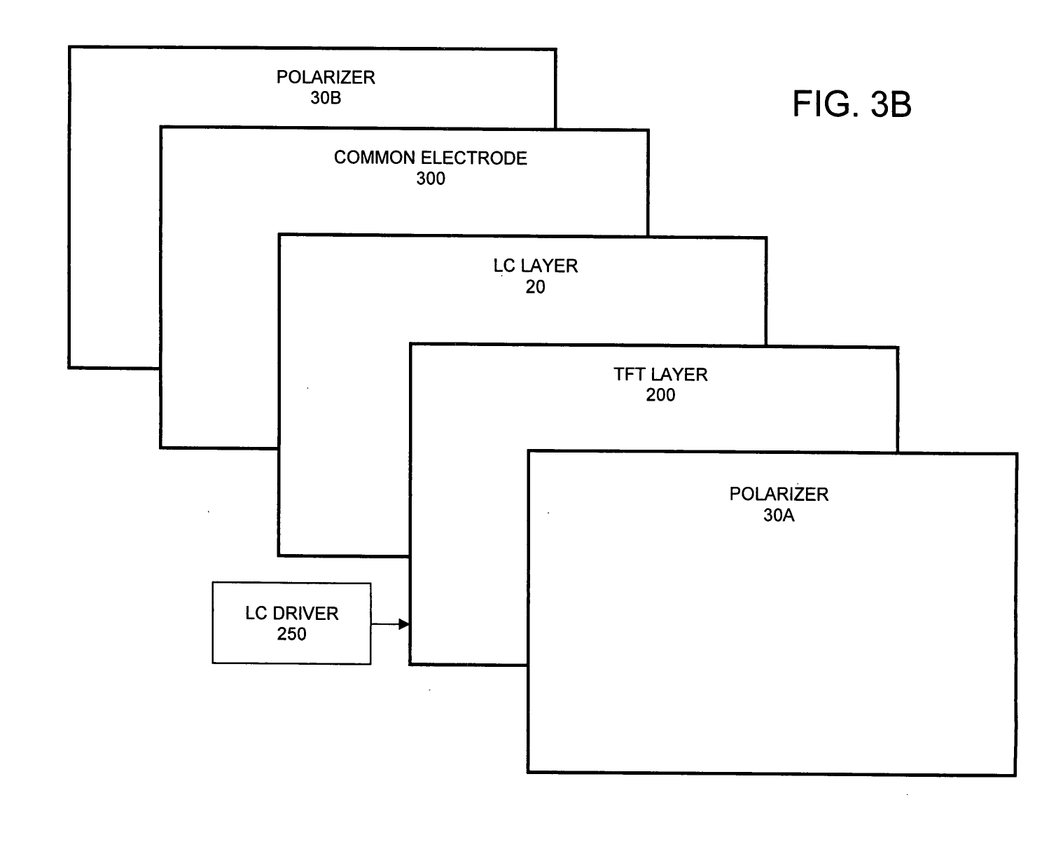

The configuration of a backlit LCD device 100, according to exemplary embodiments, is conceptually shown in FIGS. 3A and 3B. As shown in FIG. 3A, the LCD device 1 includes a liquid crystal (LC) layer 20 sandwiched between two polarizing filters 30A and 30B (hereafter “polarizers”). The LC layer 20 may be protected by a transparent front protective sheet 10, e.g., a glass plate. One or more strobing backlight sources 50 are situated behind the LC layer 20 and polarizing layers 30A and 30B. A casing or enclosure 70 is provided to hold the various layers in place. FIG. 3B illustrates an exploded view of the stack of LCD layers described above. The specification may collectively refer to these layers as the “LCD stack” of the LCD device 1.

According to an exemplary embodiment, a light diffusing film 40 (hereafter “diffuser”) may be disposed in front of the strobing backlight source. However, since the diffuser is not always required, it is drawn with dotted lines. Another optional layer in FIG. 3A is the reflective surface 60 (also drawn with dotted lines).

Furthermore, as shown in FIG. 3A, an LC driver circuit 250 is provided for refreshing, or updating, the LC layer 20. Also, at least one backlight driver 500 is implemented in the device 1 for controlling the strobed emissions of the backlight source(s) 50.

Operation of the LCD device 1 of FIG. 3A is as follows. The strobing backlight source(s) 50 emit(s) the backlight toward the LCD stack, under the control of the backlight driver circuit(s) 500. The diffuser 40 (optional) may be used for diffusing the backlight to make the intensity or brightness more uniform across the LCD panel.

Polarizers 30A and 30B are cross-polarized with respect to each other. As such, the backlight passing through polarizer 30B would be unable to pass through polarizer 30A, unless it is rotated to some extent by the LC layer 20. The LC layer 20 is made up of liquid crystal cells, each operable to selectively rotate the backlight. The degree to which each LC cell rotates the backlight is dependent upon the amount of voltage applied across the cell.

In order to drive a particular LC cell, a pair of electrodes may be positioned across the cell to apply a certain voltage, thereby “twisting” the liquid crystal molecules in the cell. This causes the backlight to rotate to some degree, consistent with the applied voltage, so that a desired amount of backlight from the cell will pass through polarizer 30A. Thus, each LC cell is updated to a desired level of transmissivity based on the voltage applied by these electrodes.

For example, as illustrated in FIGS. 3A and 3B, the driving voltage may be applied to each LC cells by an electrode in the thin-film transistor (TFT) circuit 200 and a common electrode 300. An LC driver unit 250 controls the updating of each LC cell by instructing the TFT circuit 200 to apply a particular voltage level across the cell. Thus, the LC driver unit 250 is responsible for driving each cell to the desired level of transmissivity during the refresh cycle.

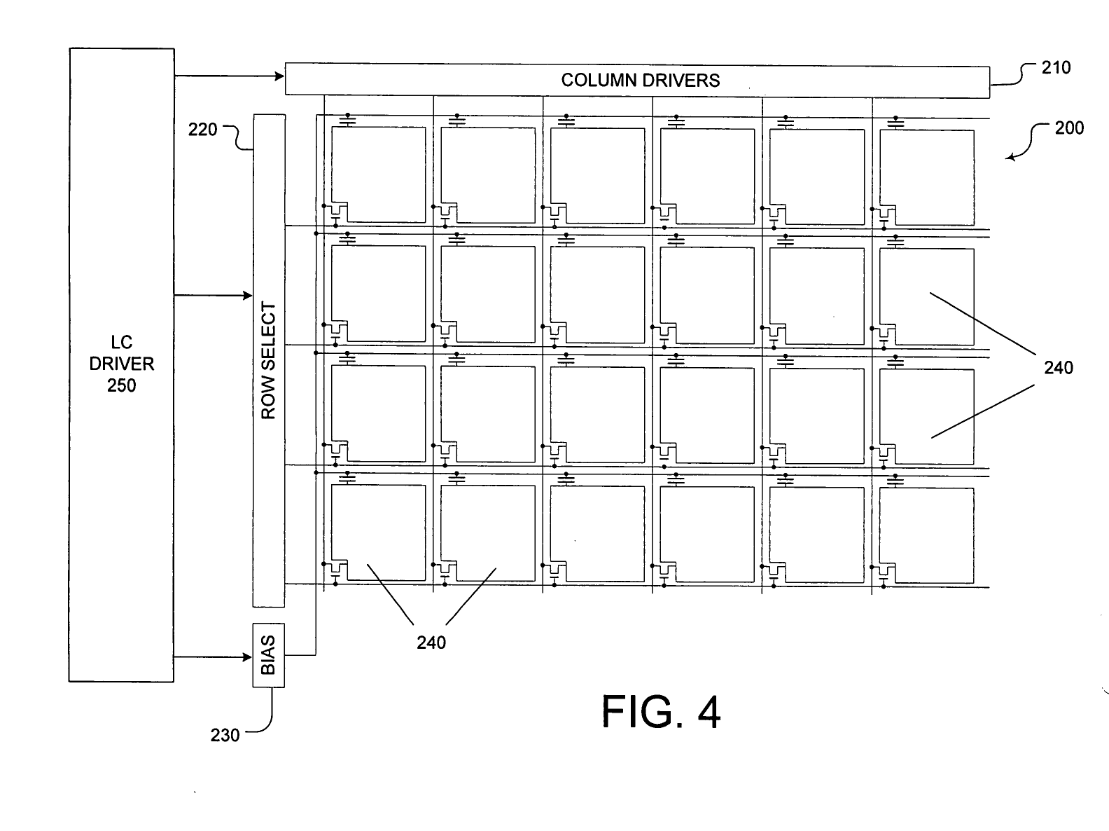

FIG. 4 provides a more detailed illustration of the TFT circuit 200. In FIG. 4, the TFT circuit 200 includes a column select unit 210, a row select unit 220, and a bias unit 230. Also, the TFT circuit 200 includes a plurality of electrodes 240 corresponding to the individual cells in LC layer 20. The LC driver unit 250 may select a particular row of cells to update by sending a control signal to the corresponding row select unit 220. To specify the desired level of transmissivity for the cells in the selected row, the output levels of the column drivers are related to the desired transmissivities of the cells in that row. This causes a desired voltage level to be applied to each selected LC cell.

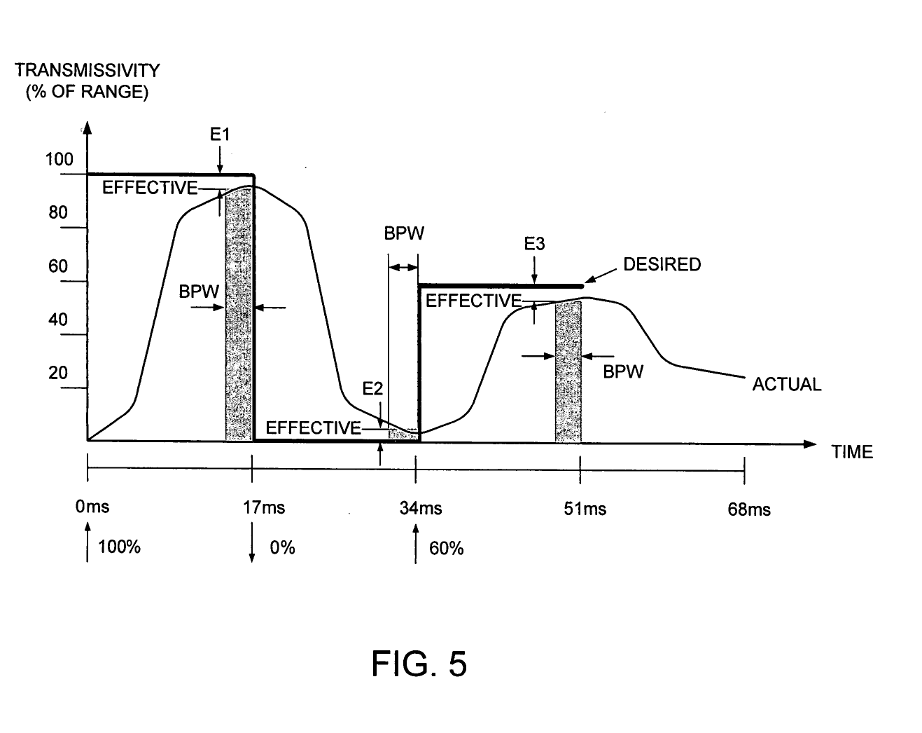

According to exemplary embodiments of the present invention, the update cycles of the LC cells are synchronized to the strobed timing of the backlight source(s) 50. Thus, as shown in FIG. 3A, the backlight driver circuit(s) 500 may communicate with the LC driver unit 250 in order to synchronize the strobed backlight 50 to the update cycles of the LC cells. For instance, the strobe timing of the backlight(s) should be compatible with the transmissivity response characteristic and refresh rate associated with the plurality of LC cells, as will be described in more detail in connection with FIG. 5.

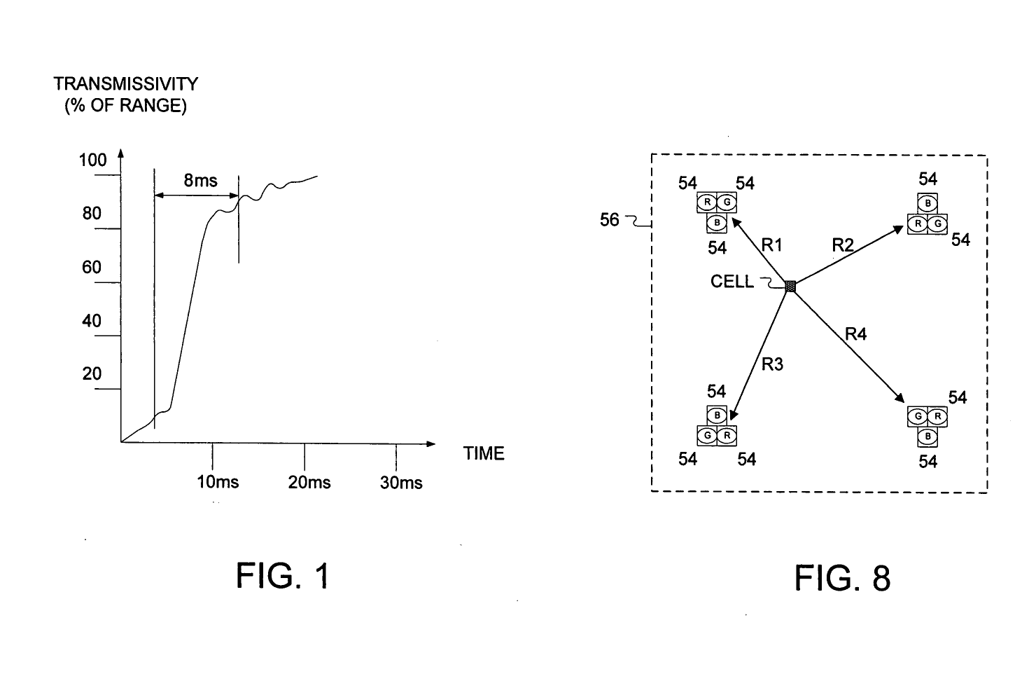

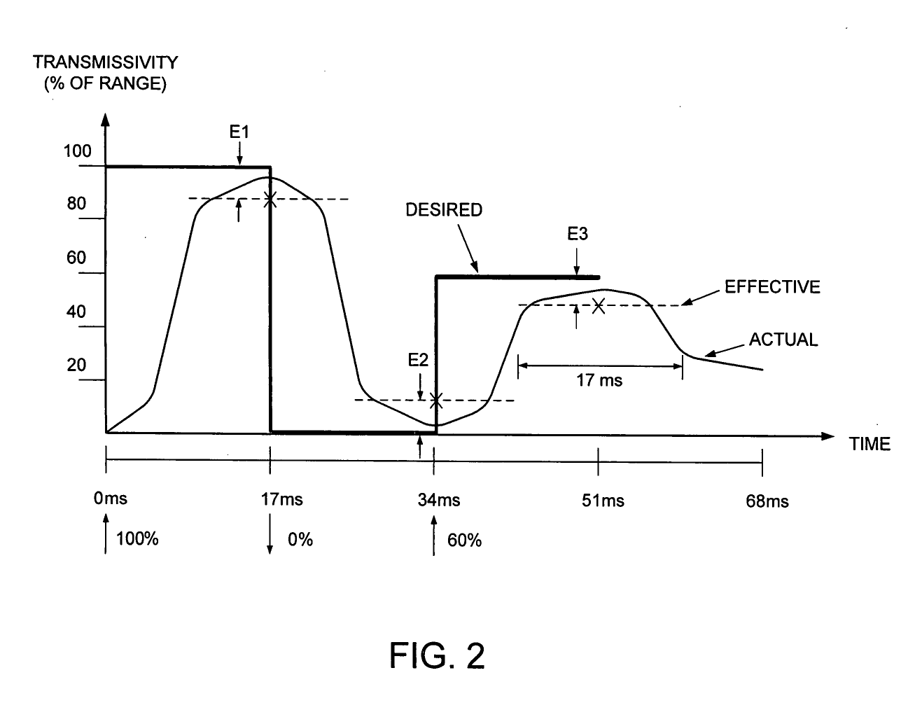

FIG. 5 illustrates an example of synchronizing the updating of an LC cell and the strobe timing of a corresponding backlight source 50, according to an embodiment of the present invention. For purposes of comparison, FIG. 5 illustrates a refresh cycle of 17 mSec, similar to FIG. 1. Also for purposes of comparison, FIG. 5 illustrates a transition response characteristic for the cell (as indicated by actual transmissivity values) similar to FIG. 1. FIG. 5 is not intended to be limiting on the present invention, and the principles of the present invention apply equally to other refresh rates and/or transition response characteristics.

As shown in FIG. 5, according to an exemplary embodiment of the present invention, the backlight source 50 is activated for the strobed emission during the portion of each update/refresh cycle when the cell's actual transmissivity is closest to the desired transmissivity level. For example, a strobed backlight pulse may be emitted occur right before the end of the refresh cycle.

In an exemplary embodiment, each pulse emitted by the strobing backlight source(s) 50 is of a constant width, illustrated in FIG. 5 as BPW (“Backlight Pulse Width”). The width BPW of the backlight pulses is determined in accordance with the capabilities of the backlight technology being used, as well as efficiency requirements.

For example, to achieve the same level of brightness, the intensity level of each strobed pulse must be greater than that of a continuous backlight. Thus, the strobing backlight source(s) 50 is designed to emit at higher intensities than conventional (continuous) backlight sources, but not continuously. The amplitude of the backlight pulses is proportionally inverse to the pulse width BPW, such that the amplitude×BPW×strobe frequency is equal to the desired brightness. Efficiency considerations may determine the actual values. Also, as another consideration, the average frequency of updating the LC cells (and, thus, activating the strobing backlight source 50) should be above the critical flicker frequency.

Referring again to FIG. 5, the effective transmissivity for each update cycle corresponds to the amount of light integrated by the viewer's eye over the duration BPW of each backlight pulse. Since each backlight pulse occurs during a part of the refresh cycle when the cell's actual level of transmissivity is closest to the desired level, the effective transmissivity of the cell (dotted line) is much closer to the desired level. For example, the differences between the effective and desired transmissivities for the update cycles (E1, E2, and E3, respectively) are much smaller than those illustrated in FIG. 1.

According to a particular exemplary embodiment, the LCD device 1 may utilize a backlight uniformly distributed across the panel. In such an embodiment, each cell in the LC layer 20 is synchronized to the same strobe timing. For purposes of convenience only, this embodiment will be described in connection with a single backlight source 50, even though multiple emitters or components may actually be used for generating the backlight.

However, according to an alternative exemplary embodiment, the backlight may be configured as having a plurality of discrete sources 50. In such an embodiment, it would not be necessary to synchronize all of the LC cells to the same strobe timing. Specifically, the cells in the LC layer 20 may be logically grouped or partitioned according to sets or “blocks.” Each block of LC cells (or “LC block”) may be synchronized to a corresponding set of one or more strobing backlight sources 50.

First, the exemplary embodiment utilizing a single backlight source 50 (i.e., a common strobe timing) will be described.

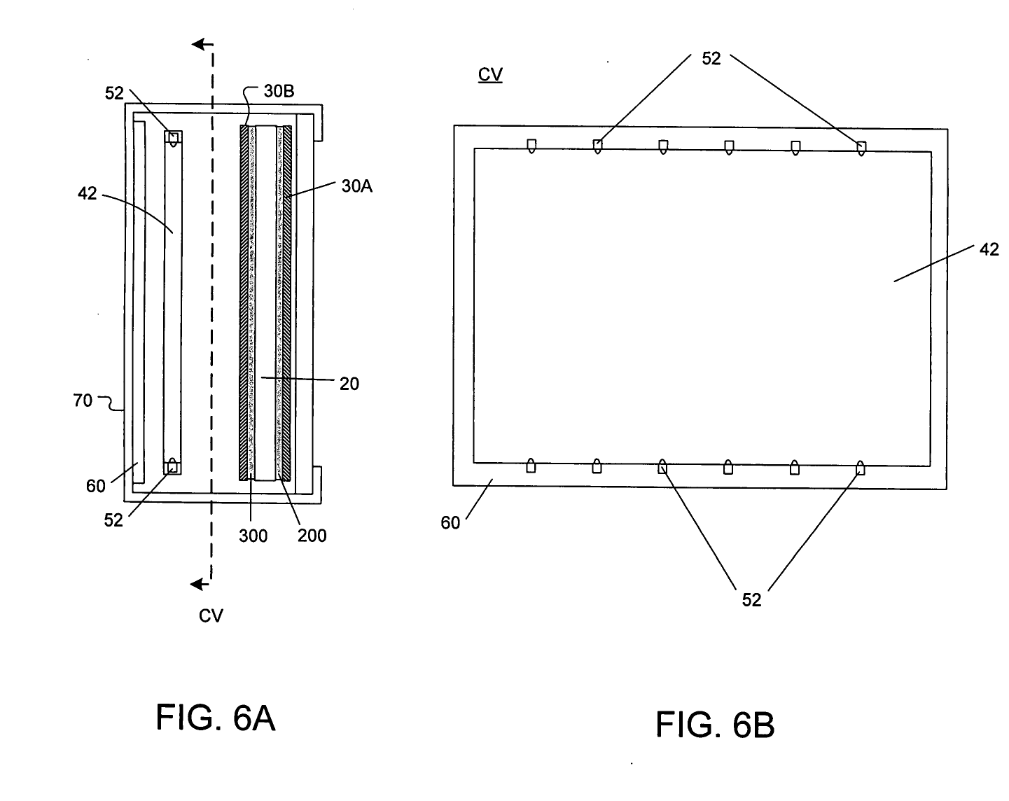

FIGS. 6A and 6B illustrate a particular type of distributed backlight source 50 that may be implemented in the LCD device 1, according to an exemplary embodiment. FIG. 6A illustrates a side view of the backlit LCD device 100, while FIG. 6B shows a cross-sectional view at CV. As illustrated in FIGS. 6A and 6B, the backlight source 50 may include a combination of “pinpoint” light sources 52, e.g., light emitting diodes (LEDs). For instance, red, blue, and green LEDs may be used. These figures also show an edge-lit light guide/diffuser 42 dedicated specifically to the pinpoint LED sources 52.

As shown in FIGS. 6A and 6B, the pinpoint light sources 52 are configured to emit light into the edge-lit light guide/diffuser 42, which is situated parallel to the LC layer 20. As such, the edge-lit light guide/diffuser 42 is intended to distribute the light from the pinpoint light sources 52 uniformly for each cell in the LC layer 20. The combination of the edge-lit light guide/diffuser 42 and LED light sources 52 is generally referred to as an LED edge-lit light guide assembly.

In this embodiment, the LEDs 52 may be strobed according to a common timing, to which each of the LC cells is synchronized. However, this does not necessarily mean that all of the LEDs 52 strobe on at the same time. If red, blue, and green LEDs 52 are used, for instance, a scheme may be employed where the different colors are strobed in sequence (e.g., red strobes, then blue, then green, etc.) to update the cells. Accordingly, the backlight driver circuit 500 (FIG. 3A) may include circuitry to drive the red, blue, and green LEDs 52 sequentially, in accordance with the strobe timing.

The cells in the LC layer 20 are synchronized to the strobe timing of a single distributed backlight source 50, e.g., the edge-lit light guide assembly of FIGS. 6A and 6B. Specifically, each strobe pulse should occur during the portion of the refresh cycle when the cells' effective transmissivities are closest to the desired level (as driven by the LC driver unit 250). An example of this is described above in connection with FIG. 5. In order to achieve such synchronization between each cell in the LC layer 20 and the strobe timing of the distributed backlight source 50, an additional full image buffer (not shown) may be needed. However, in an alternative embodiment utilizing multiple discrete backlight sources 50, the need for this buffer may be avoided.

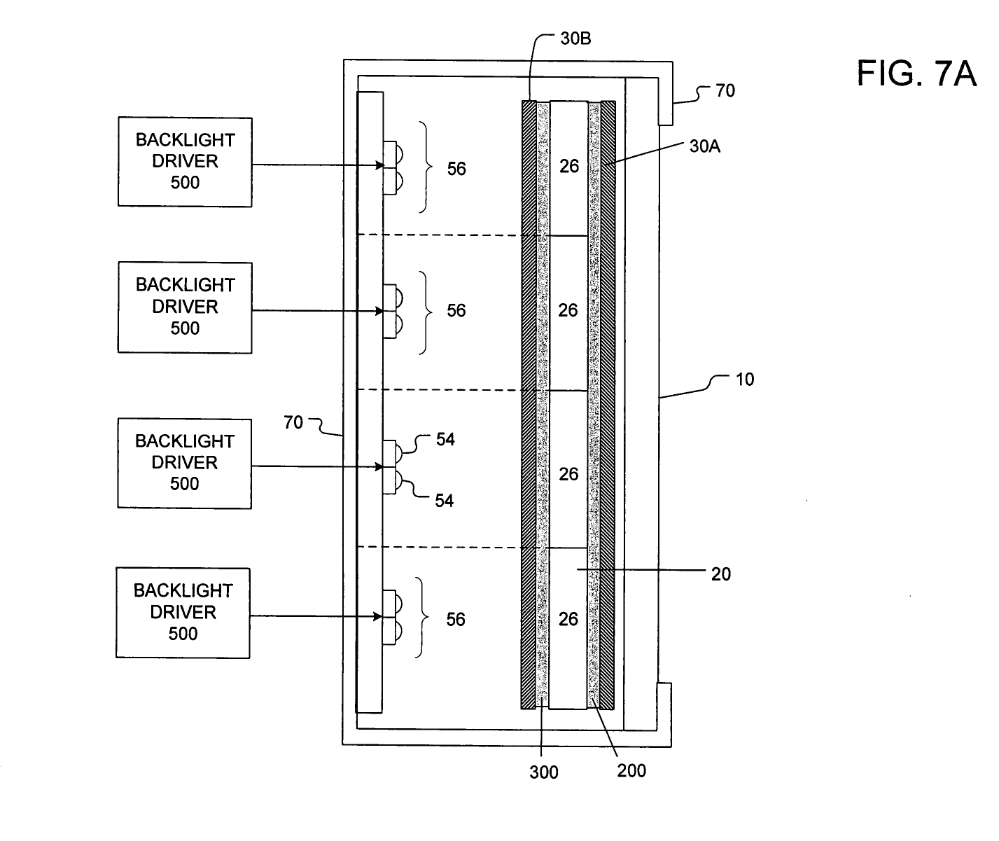

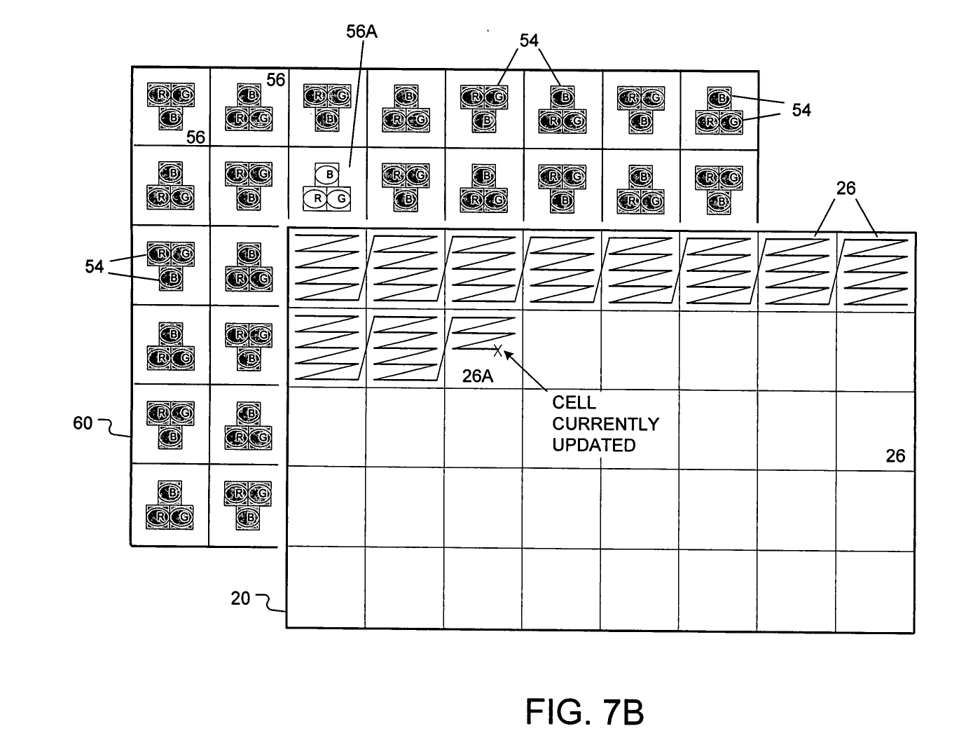

An alternative exemplary embodiment of multiple discrete strobing backlight sources 50 is illustrated in FIGS. 7A and 7B. Particularly, FIG. 7A illustrates a side view of a particular example in which multiple LEDs 54 are disposed behind the LCD stack (e.g., on a reflective surface 60). As shown in FIG. 7A, the LEDs 54 are logically partitioned or divided into backlight blocks 56. FIG. 7A also shows the LC layer 20 being logically partitioned into a corresponding set of LC blocks 26.

According to this embodiment, each backlight block 56 may operate according to its own strobe timing. Thus, for each backlight block 56, there may be a separate backlight driver circuit 500 to drive the corresponding set of LEDs 54. Further, the updating of cells within each LC block 26 are synchronized to the strobe timing of the corresponding backlight block 56. Thus, in this embodiment, the LC layer 20 is physically a single panel, for which a block oriented updating process is employed.

FIG. 7B illustrates a scanning process for updating the LC cells (and activating backlight sources), according to an exemplary embodiment. Particularly, FIG. 7B illustrates an embodiment in which the LC blocks 26 are sequentially updated, one at a time, and the cells within each block 26 are updated sequentially, one at a time. Furthermore, the backlight blocks 56 are activated in a sequence corresponding to the updating of LC blocks 26. Thus, as shown in FIG. 7B, after the cells of LC block 26A are updated, and allowed to reach a transmissivity value as close as possible to the desired value, then the corresponding block of backlight sources 56A is strobed.

The updating of each cell is synchronized to the strobe timing of the corresponding backlight block 56. Specifically, to enhance performance, the backlight block 56 should strobe on when the cell's effective transmissivity is closest to the desired level. As described above in connection with FIG. 5, this generally occurs near the end of the cell's refresh cycle. Thus, each of the LC backlight driver units 500 may communicate with the LC driver unit 250 (not shown in FIG. 7A) to synchronize the strobe timings with the cell update cycles.

FIG. 7B shows a particular example where each backlight block 56 includes a red, blue, and green LED 54. While, for each backlight block 56, the LEDs 54 are driven according to a common strobe timing, the LEDs 54 do not necessarily strobe on at the same time. For instance, the colors may be strobed in sequence, in order to update each cell in the corresponding LC block 26.

It should be noted that FIG. 7B illustrates an exemplary scanning pattern for updating the LC blocks 26, and the cells therein, during each image refresh cycle. Other scanning patterns may be employed for updating the LC cells. Furthermore, it may be possible to update multiple LC blocks 26 simultaneously.

Also, while FIG. 7B illustrates one red, blue, and green LED 54 in each backlight block 56, this is merely exemplary. An example of this is illustrated in FIG. 8. Multiple LEDs 54 of the same color may be implemented in the block 56, e.g., in order to increase output intensity.

Particularly, FIG. 8 illustrates a particular cell and the corresponding backlight block 56. In the block 56 are four sets of red, blue, and green LEDs 54, each contributing to the output of an individual exemplary LC cell (labeled “CELL” in FIG. 8). To achieve a certain level of brightness for the pixel, which corresponds to the given cell, the LC driver unit 250 may take into account the averaged backlight intensity at the cell's location when driving the cell to a particular transmissivity level. Particularly, in the example of FIG. 8, the averaged backlight intensity may be determined based on the respective distances R1-R4 between the cell and the sets of LEDs 54, as described in copending U.S. patent application Ser. No. 11/375,116, entitled “DISPLAY WITH REDUCED POWER BACKLIGHT,” filed on Mar. 15, 2006, the entire contents of which are herein incorporated by reference.

Exemplary embodiments having been described above, it should be noted that such descriptions are provided for illustration only and, thus, are not meant to limit the present invention as defined by the claims below. Any variations or modifications of these embodiments, which do not depart from the spirit and scope of the present invention, are intended to be included within the scope of the claimed invention.

What is claimed is:

1. A liquid crystal display device, comprising:
a strobing backlight source; and
a liquid crystal (LC) layer including a plurality of LC cells configured to selectively transmit emissions from the strobing backlight source,
wherein the plurality of LC cells are updated in synchronization with a strobe timing of the strobing backlight source.

2. The device of claim 1, further comprising:
an LC driver unit configured to update the plurality of LC cells in accordance with the refresh rate; and
a backlight driver circuit configured to control the strobed emissions of the strobing backlight source,
wherein the LC driver unit communicates with the backlight driver unit to synchronize the updating of LC cells to the strobe timing.

3. The device of claim 1, wherein the strobe timing of the strobing backlight source is determined in accordance with the refresh rate and a transmissivity response characteristic associated with the plurality of LC cells.

4. The device of claim 3, wherein
the transmissivity response characteristic corresponds to a transition period between desired levels of transmissivity in consecutive update cycles for the plurality of LC cells, and
the strobing backlight source is configured to emit backlight pulses with a duration and intensity in accordance with the transition period.

5. The device of claim 4, wherein the duration and intensity of each backlight pulse is set in accordance with predetermined levels of effective transmissivity and efficiency for the plurality of LC cells.

6. The device of claim 1, wherein, for each update cycle of a particular LC cell, the LC driver unit generates a control signal based on a desired transmissivity level for the particular LC cell, and
the strobing backlight source emits a backlight pulse for the particular LC cell during a portion of the update cycle when an effective transmissivity level of the particular LC cell is closest to the desired transmissivity level.

7. The device of claim 1, wherein the strobing backlight source is configured to uniformly distribute the backlight across the LC layer, and
the LC driving unit includes an image buffer for synchronizing each LC cell's update cycles to the strobe timing.

8. The device of claim 1, wherein the LC layer is logically partitioned into blocks of LC cells, the device further comprising:
a plurality of strobing backlight sources, each designated for a particular block of LC cells.

9. The device of claim 8, wherein the plurality of strobing backlight sources comprises a plurality of light-emitting diodes (LEDs).

10. The device of claim 8, wherein the plurality of strobing backlight sources are logically partitioned into blocks, such that each block of strobing backlight sources is designated for a particular block of LC cells.

11. The device of claim 10, further comprising an LC driver unit,
wherein the LC driver unit is configured to update a particular block of LC cells by sequentially updating each LC cell in the particular block according to a scanning pattern, in synchronization with the strobe timing of the designated block of strobing backlight sources.

12. The device of claim 11, further comprising a plurality of backlight driver circuits, each configured to control a corresponding block of strobing backlight sources,
wherein the LC driver unit communicates with each backlight driver circuit to synchronize the updating of each block of LC cells to the strobed emissions of the designated block of strobing backlight sources.

13. The device of claim 10, wherein each LC cell in a particular block of LC cells is updated to achieve a level of transmissivity commensurate with an averaged intensity level associated with the corresponding block of strobing backlight sources.

14. A liquid crystal display device, comprising:
a plurality of strobing backlight sources; and
a liquid crystal (LC) layer including a plurality of LC cells updated according to a predetermined refresh rate,
wherein, for each LC cell,
one or more strobing backlight sources, with a common strobe timing, contribute to the output of the LC cell, and
during each update cycle of the LC cell, the one or more strobing backlight sources strobe on at a time when the cell's effective transmissivity level is closest to a desired transmissivity level.

15. The device of claim 14, wherein the LC layer is logically partitioned into blocks of LC cells, and each of the plurality of strobing backlight sources is designated for a particular block of LC cells.

16. The device of claim 15, wherein the plurality of strobing backlight sources comprises a plurality of light-emitting diodes (LEDs).

17. The device of claim 15, wherein the plurality of strobing backlight sources are logically partitioned into blocks, such that each block of strobing backlight sources is designated for a particular block of LC cells.

18. The device of claim 17, further comprising an LC driver unit,
wherein the LC driver unit is configured to update a particular block of LC cells by sequentially updating each LC cell in the particular block according to a scanning pattern, in synchronization with the strobe timing of the designated block of strobing backlight sources.

19. The device of claim 18, further comprising a plurality of backlight driver circuits, each configured to control a corresponding block of strobing backlight sources,
wherein the LC driver unit communicates with each backlight driver circuit to synchronize the updating of each block of LC cells to the strobed emissions of the designated block of strobing backlight sources.

20. The device of claim 17, wherein each LC cell in a particular block of LC cells is updated to achieve a level of transmissivity commensurate with an averaged intensity level associated with the corresponding block of strobing backlight sources.
